(19) United States
(12) Patent Application Publication
(10) Pub. No.: US 2013/0213221 A1
(43) Pub. Date: Aug. 22, 2013

(54) PISTON RING FOR AN INTERNAL COMBUSTION ENGINE

(71) Applicant: Federal-Mogul Corporation, (US)

(72) Inventors: Blair Matthew Jenness, Grosse Pointe Park, MI (US); Matthew Ryan Pedigo, Howell, MI (US); Troy Kantola, Whitmore Lake, MI (US)

(73) Assignee: Federal-Mogul Corporation, Southfield, MI (US)

(21) Appl. No.: 13/768,435

(22) Filed: Feb. 15, 2013

Related U.S. Application Data
(60) Provisional application No. 61/600,216, filed on Feb. 17, 2012.

(51) Int. Cl. F16J 9/04

(52) U.S. Cl. CPC F16J 9/04
USPC 92/208; 277/458

(57) ABSTRACT

A piston assembly including a piston body and a piston ring is provided. The piston body has a skirt, a portion of which extends circumferentially continuously and has a skirt diameter. The piston ring has a ring body which extends through at least one revolution in a generally helical shape when in a relaxed condition. The ring body also has an inner face, and when in the relaxed condition, the inner face presents a ring diameter which is less than the skirt diameter. The ring body circumferentially surrounds the skirt of the piston body, thereby causing the inner face to be biased into engagement with the outer surface of the circumferentially continuous portion of the skirt of the piston body to establish a dynamic seal between the ring body and the piston body.

### CROSS-REFERENCE TO RELATED APPLICATION

This application claims the benefit of application Ser. No. 61/600,216 filed Feb. 17, 2012.

### BACKGROUND OF THE INVENTION

1. Field of the Invention

The present invention relates generally to internal combustion engines having at least one reciprocating piston within a cylinder, and more particularly to seals between the reciprocating piston and a cylinder wall.

2. Related Art

Typical internal combustion engines are provided with at least one piston body which reciprocates within a cylinder of an engine block. In general, each piston body includes a plurality of ring grooves, each of which receives and operably supports a piston ring. In operation, the piston rings remain in the ring grooves and travel with their respective piston bodies in a reciprocating motion within cylinders of an engine block. Among other things, the pistons rings function to seal combustion gasses in a combustion chamber above the piston body, to transfer heat from the piston body to the cylinder wall, to restrict the passage of oil from the crank case to the combustion chamber and to provide a generally uniform oil film on the cylinder wall. Such piston rings are typically biased with a spring force in a radially outward direction against the cylinder wall to establish the seal between the piston body and the cylinder wall.

### SUMMARY OF THE INVENTION

One aspect of the present invention provides for a piston assembly including a piston body having a skirt. At least a portion of the skirt extends circumferentially continuously and has a skirt diameter. The piston assembly also includes a piston ring having a ring body with a generally helical shape and having an inner face. The ring body extends through at least one full revolution when in a relaxed condition. When in a relaxed condition, the inner face of the ring body presents a ring diameter that is less than the skirt diameter. The ring body circumferentially surrounds the skirt of the piston body, causing the inner face to be biased into engagement with the outer surface of the circumferentially continuous portion of the skirt to establish a dynamic seal between the ring body and the piston body.

The piston ring may be seated in a channel of a cylinder wall to establish the seal between the cylinder wall and the piston body. As such, the piston ring remains generally stationary and does not move relative to the cylinder wall during operation of the engine. This location allows for increased stability of the piston body as it reciprocates in the cylinder of the engine without compromising the length of the skirt, i.e. the skirt may extend downwardly past the cylinder wall when the piston body is in a bottom dead center position. The piston ring is also resistant to blow by.

Another aspect of the present invention provides for a power cylinder assembly. The power cylinder assembly includes a cylinder wall having a circumferentially continuous channel formed therein. The power cylinder assembly also includes a piston body with a skirt, and at least a portion of an outer surface of the skirt extends substantially continuously around a circumference. This portion of the skirt has a generally continuous skirt diameter. The power cylinder assembly further includes a piston ring which is disposed in the channel of the cylinder wall. The piston ring has a ring body which extends through at least one full revolution in a generally helical shape when the ring body is in a relaxed condition. When in the relaxed condition, the ring body has an inner face which presents an inner diameter that is less than the skirt diameter of the piston body. The ring body circumferentially surrounds the skirt of the piston body, and the inner face is biased into engagement with the outer surface of the circumferentially continuous portion of the skirt to establish a seal between the cylinder wall and the piston body.

Yet another aspect of the present invention is a piston ring for sealing a cylinder wall to a piston body. The piston ring has a ring body with a generally helical shape that extends through at least one revolution when in a relaxed condition. The ring body has an inner face that is rounded or chamfered to dynamically engage a piston body.

### BRIEF DESCRIPTION OF THE DRAWINGS

These and other features and advantages of the present invention will be readily appreciated, as the same becomes better understood by reference to the following detailed description when considered in connection with the accompanying drawings wherein:

FIG. 1 is a perspective and elevation view of an exemplary embodiment of a piston ring;

FIG. 2 is a sectional view of an exemplary embodiment of a power cylinder assembly and including the piston ring of FIG. 1 and showing a piston body in a top dead center position;

FIG. 3 is another sectional view of the exemplary embodiment of the power cylinder assembly with the piston ring of FIG. 1 and showing the piston body in a bottom dead center position;

FIG. 4 is a cross-sectional and fragmentary view showing the piston ring of FIG. 1 disposed within a channel of a cylinder wall and in sealing engagement with a piston body; and

FIG. 5 is a top elevation view of the piston ring of FIG. 1.

### DESCRIPTION OF THE ENABLING EMBODIMENT

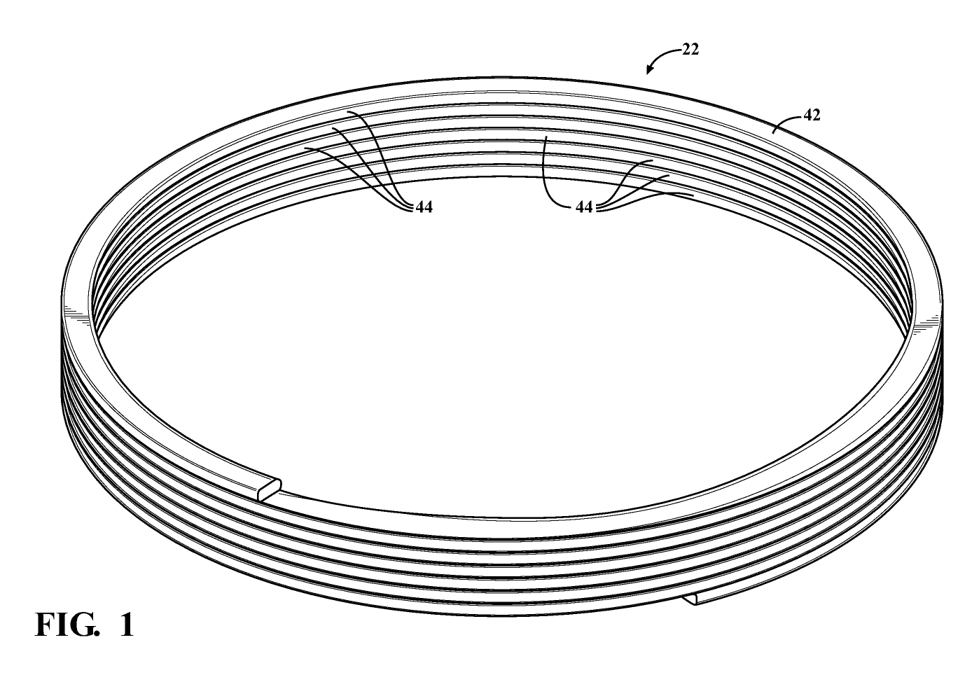

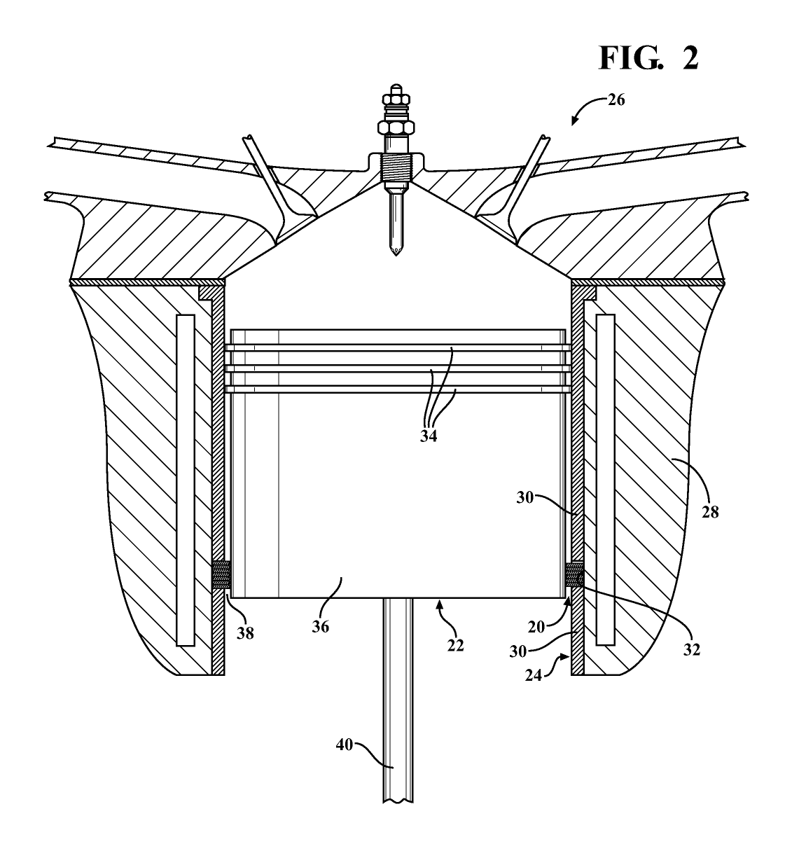

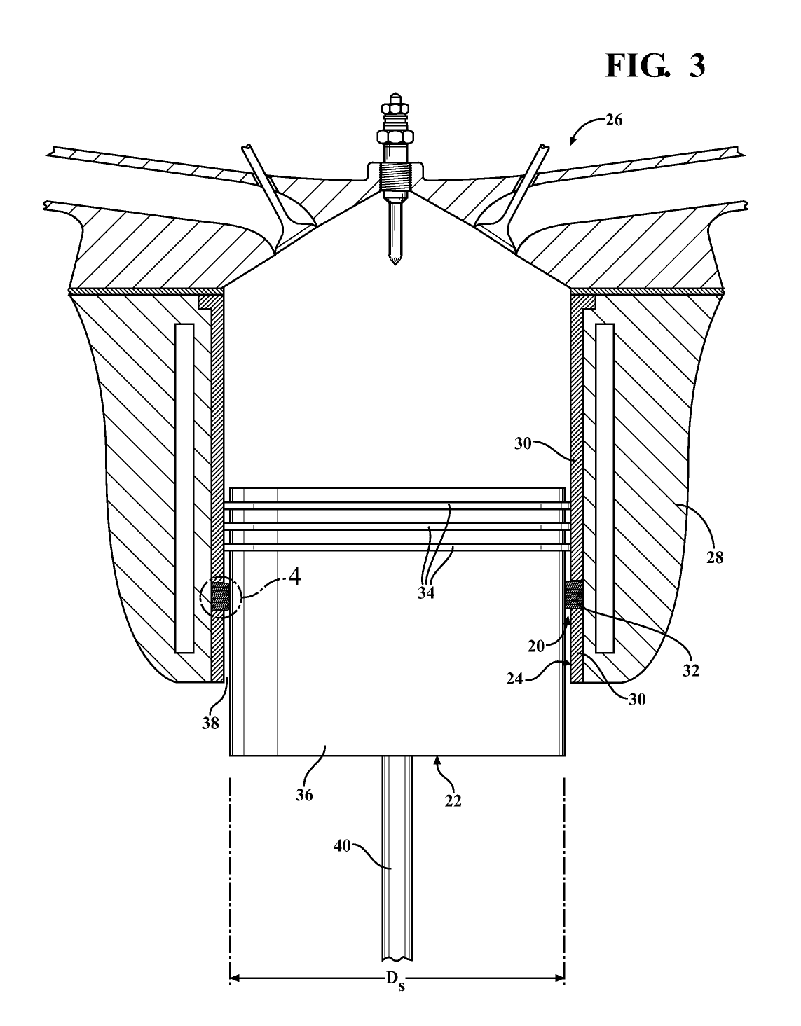

Referring to the Figures, wherein like numerals indicate corresponding parts throughout the several views, an exemplary embodiment of a piston ring 20 for sealing a piston body 22 to a cylinder wall 24 of a power cylinder assembly 26 of an internal combustion engine is generally shown in FIG. 1. Referring now to the cross-sectional views of FIGS. 2 and 3, the exemplary piston ring 20 is shown as installed in a power cylinder assembly 26 of an internal combustion engine having an engine block 28 and a two-piece cylinder liner 30 which together present an axially extending cylinder wall 24 having a channel 32 that extends substantially circumferentially around the cylinder wall 24. Specifically, in the exemplary embodiment, the piston ring 20 is disposed between ends of the cylinder liner 30 pieces which are spaced axially from one another to present the aforementioned channel 32. However, it should be appreciated that the channel 32 could be formed into the cylinder wall 24 through a range of different manners. For example, the channel 32 could be formed directly into the engine block 28 without any cylinder liner 30. The exemplary piston ring 20 is shown installed in a diesel fueled compression ignition engine; however, it should be appreciated that the piston ring 20 could alternately be used in a range of different types of internal combustion engines including, for example, spark ignition engines or horizontally opposed two piston per cylinder engines.

Referring still to FIGS. 2 and 3, the piston body 22 of the exemplary power cylinder assembly 26 includes one or more upper piston rings 34 (a plurality being illustrated in the exemplary embodiment) which are carried in associated ring grooves formed in the outer wall of the piston body 22. The piston body 22 also has a skirt 36 which depends from the piston ring 20 region and helps guide the piston body 22 during reciprocation within the cylinder during operation of the engine. At least a portion of the skirt 36 is generally cylindrically-shaped and has an outer surface which extends continuously around a circumference. Specifically, the outer surface of the circumferentially continuous portion of the skirt has a skirt diameter Dₛ. This portion of the skirt 36 is sized to be close to but relatively smaller than the inner diameter of the cylinder wall 24 such that there is an operating gap 38 therebetween. The piston body 22 is coupled by a wrist pin (not shown) or a similar type of connection device to a connecting rod 40, which in turn is coupled to a crank shaft (not shown) or a similar mechanism.

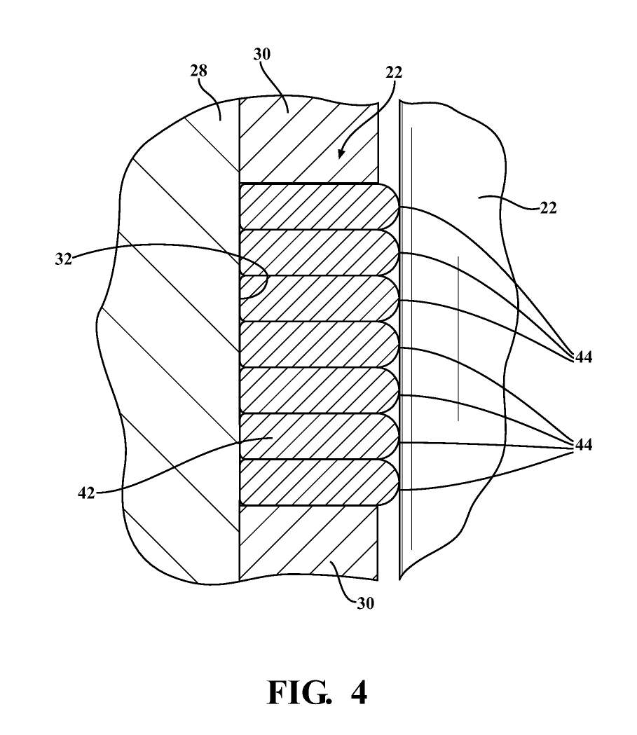

Referring still to FIGS. 2 and 3, in its location in the channel 32 of the cylinder wall 24, the exemplary piston ring 20 is mounted stationarily relative to the engine block 28 and is sealed against the outer surface of the skirt 36 of the piston body 22 to establish a gas and fluid tight seal between the cylinder wall 24 and the piston body 22. The piston ring 20 has an inner face 42 (best shown in FIG. 4) that is in running contact with the skirt 36 of the piston body 22 during operation of the engine to seal combustion gasses in the combustion chamber on one side of the piston body 22 and to seal oil on the other side of the piston body 22, e.g. in a crank case (not shown) or any other oil chamber. During operation of the engine, the piston body 22 moves up and down within the cylinder wall 24 between a top dead center position shown in FIG. 2 and a bottom dead center position shown in FIG. 3. As shown, the exemplary piston ring 20 remains in sealing engagement with the circumferentially continuous portion of the skirt 36 to maintain the gas and oil tight seal throughout the piston body's 22 range of travel. The location of the piston ring 20 in the channel 32 of the cylinder wall 24 allows for increased stability of the piston body 22 as it reciprocates in the cylinder of the engine without compromising the length of the skirt 36, i.e. the skirt 36 may extend downwardly into the crank case (not shown) when the piston body 22 is in the bottom dead center position.

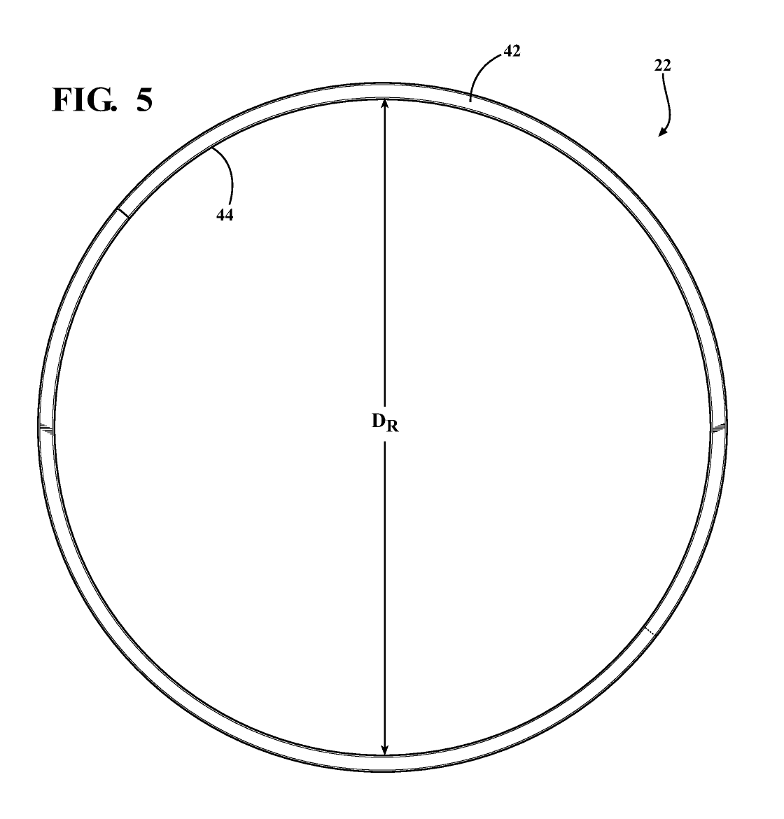

Referring back to FIG. 1, the piston ring 20 includes a ring body 42 which has a generally helical shape and extends about an axis through one or more revolutions when in a relaxed condition. For example, in the exemplary embodiment, the ring body 42 extends through approximately seven full revolutions when in a relaxed condition. The ring body 42 has a continuous inner face 44 which faces towards the axis about which the ring body 42 extends. As shown in FIG. 5, as viewed from above or below the piston ring 20, the inner face 44 extends through a circumference having a ring diameter D_{R} which is less than the skirt diameter Dₛ of the skirt 36 of the piston body 22.

To install the ring body 42 onto the skirt 36 of a piston body 22, the ring body 42 must be spread, or unwound, partially to elastically deflect the material of the ring body 42, thereby temporarily increasing the ring diameter D_{R} to greater than the skirt diameter Dₛ. The ring body 42 is then inserted over the skirt 36 of the piston body 22 and relaxed, thereby causing the inner face 44 to be biased with a spring force internal to the ring body 42 against the outer surface of the piston body 22.

Referring now to FIG. 4, the ring body 42 of the exemplary embodiment is shown seated and sealed within the channel 32 of the cylinder wall 24 and biased against the outer surface of the piston body 22 to establish the gas and oil tight seal between the cylinder wall 24 and the piston body 22. As shown, the inner face 44 of the ring body 42 is rounded. However, it should be appreciated that the inner face 44 could alternately be chamfered or have any suitable shape for sealing against the outer surface of the piston body 22 or could have a varyable geometry. The continuous inner face 44 provides the ring body 42 with a helically-shaped line or surface of contact with the piston body 22. This provides for circumferentially continuous oil scraping and gas and oil sealing performance.

The ring body 42 may be formed through any desirable manufacturing process and may be of any suitable spring-like material including, for example, spring steel. The ring body 42 may also either be uncoated or may have a wear resistant coating (such as chromium, chromium with aluminum oxide ceramic [CKS], chromium with microdiamond [GDC], etc.) applied to the inner face 44. The material and geometry of the ring body 42 are preferably chosen to provide a gas and oil tight seal between the cylinder wall 24 and the piston body 22 while minimizing the friction between the ring body 42 and the piston body 22.

The exemplary description of the embodiment is meant to be illustrative and not limiting of the invention. Variations and modifications to the disclosed embodiment may become apparent to those skilled in the art and come within the scope of the invention.

What is claimed is:

1. A piston assembly, comprising:
a piston body having a skirt, wherein at least a portion of an outer surface of said skirt extends circumferentially continuously and has a skirt diameter;
a ring body having a generally helical shape, said ring body extending through at least one full revolution when in a relaxed condition, and said ring body having an inner face presenting a ring diameter that is less than said skirt diameter when said ring body is in said relaxed condition; and
said ring body circumferentially surrounding said skirt of said piston body with said inner face of said being biased into engagement with said outer surface of said circumferentially continuous portion of said skirt to establish a seal between said ring body and said piston body.

2. The piston assembly as set forth in claim 1 wherein said inner face of said ring body is rounded or chamfered.

3. The piston assembly as set forth in claim 2 wherein said inner face of said ring body is rounded.

4. The piston assembly as set forth in claim 1 wherein said ring body extends through a plurality of revolutions when in said relaxed condition.

5. A power cylinder assembly, comprising:
a cylinder wall having a channel formed therein, said channel extending substantially circumferentially around said cylinder wall;
a piston body having a skirt and wherein at least a portion of an outer surface of said skirt extends substantially continuously around a circumference with a skirt diameter;
a piston ring disposed in said channel of said cylinder wall, said piston ring having a ring body with a generally helical shape, said ring body extending through at least one full revolution when in a relaxed condition, and said ring body having an inner face presenting a ring diameter that is less than said skirt diameter when said ring body is in a relaxed condition; and
said ring body circumferentially surrounding said skirt of said piston body with said inner face being biased into engagement with said outer surface of said circumferentially continuous portion of said skirt to establish a seal between said cylinder wall and said piston body.

6. The power cylinder assembly as set forth in claim 5 wherein said inner face of said ring body is rounded or chamfered.

7. The power cylinder assembly as set forth in claim 6 wherein said inner face of said ring body is rounded.

8. The power cylinder assembly as set forth in claim 5 wherein said ring body extends through a plurality of revolutions when in said relaxed condition.

9. The power cylinder assembly as set forth in claim 5 wherein said inner face of said piston ring is uncoated.

10. A piston ring for sealing a cylinder wall to a piston body, comprising:
a ring body having a generally helical shape and extending through at least one revolution; and
said ring body having an inner face that is rounded or chamfered to dynamically engage a piston body.
